(19) United States
(12) Patent Application Publication
(10) Pub. No.: US 2024/0307994 A1
(43) Pub. Date: Sep. 19, 2024

(54) ULTRASONICALLY WELDED FITTINGS AND WELDING CABLES

(71) Applicant: Illinois Tool Works Inc., Glenview, IL (US)

(72) Inventor: Bradley Eugene Whipple, South Woodslee (CA)

(21) Appl. No.: 18/605,623

(22) Filed: Mar. 14, 2024

Related U.S. Application Data
(60) Provisional application No. 63/490,369, filed on Mar. 15, 2023.

(51) Int. Cl. B23K 20/10; H01R 43/02

(52) U.S. Cl. CPC B23K 20/10; H01R 43/0207

(57) ABSTRACT

Disclosed example welding cables include: an outer jacket; a plurality of strands of conductive wire arranged within the outer jacket; a conduit within the outer jacket; and a fitting configured to couple the welding cable to an external device, the fitting comprising a body having a bore in communication with the gas conduit and having a conductive surface ultrasonically welded to the plurality of strands of the conductive wire.

### RELATED APPLICATIONS

The present application claims the benefit of U.S. Provisional Patent Application Ser. No. 63/490,369, filed Mar. 15, 2023, entitled “ULTRASONICALLY WELDED FITTINGS AND WELDING CABLES.” The entirety of U.S. Provisional Patent Application Ser. No. 63/490,369 is expressly incorporated herein by reference.

### FIELD OF THE DISCLOSURE

This disclosure is generally related to welding cables and, more particularly, to ultrasonically welded fittings and welding cables.

### BACKGROUND

In an electric arc welding process, it is known to use a power cable for conducting current, shielding gas, and electrode wire through a welding torch. The power cable is often referred to as a unicable for an air-cooled torch, which generally includes a core tube, copper cabling, lead wires, and insulation jacket.

### SUMMARY

The present disclosure is directed to ultrasonically welded fittings and welding cables.

These and other features and advantages of the disclosure will be more fully understood from the following detailed description taken together with the accompanying drawings.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates an example robotic welding system, in accordance with aspects of this disclosure.

FIGS. 2A and 2B illustrate perspective and cross-sectional views of an example unicable construction, in accordance with aspects of this disclosure.

FIGS. 3A and 3B illustrate an example fitting having two flat surfaces that may be ultrasonically welded to the unicable of FIGS. 2A and 2B.

FIGS. 4A and 4B illustrate an example fitting having four flat surfaces that may be ultrasonically welded to the unicable of FIGS. 2A and 2B.

FIGS. 5A-D illustrate a cross-section of the example unicable of FIGS. 2A and 2B being connected to the fitting of FIGS. 3A and 3B for ultrasonic welding during a manufacturing process.

FIG. 6 is a flowchart representative of an example method to construct a welding cable using ultrasonic welding, in accordance with aspects of this disclosure.

The figures are not necessarily to scale. Where appropriate, similar or identical reference numbers are used to refer to similar or identical components.

### DETAILED DESCRIPTION

Welding cables are conventionally is connected to other torch parts by way of either a crimped or threaded compression fitting. One end of the cable is fastened to a wire feeder by way of a mating pin (or power pin), and the other end is fastened to a torch body with a gooseneck or conductor tube of the welding torch. These connections are fixed and unmoving.

The power cable provides major flexibility to the torch, such that the welding arc can be applied at various locations. However, conventional fixed connections limit the movement of the copper bundles within the unicables and creates stress, leading to eventual failure of the electrical connection of the welding torch or cable. Additionally, conventional welding cables are sensitive to the amount of pressure applied to the fittings. Insufficient pressure or excess pressure on a crimp ring can result in increased resistance and/or failure of the cable.

Disclosed example welding cables and methods of manufacturing involve welding cable conductors which are ultrasonically welded to a fitting, rather than relying on compression for maintaining physical and electrical contact. By eliminating the crimp ring, the conductive strands of disclosed example cables are not damaged by the crimp ring being forced down onto them. Elimination of the crimp ring also reduces the number of parts involved in the assembly and manufacturing, and reduces the potential for problems due to stacking of tolerances of multiple components.

Disclosed example welding cables have a lower rate of premature failure by providing more reliable way of bonding the conductor strands to the connector, and improves the conductivity of the overall cable assembly over the course of the weld cable life. By welding the copper strands to the connector, the welding cable is stronger and more resistant to failure compared to conventional welding cables.

As used herein, the terms “first” and “second” may be used to enumerate different components or elements of the same type, and do not necessarily imply any particular order.

The term “welding-type system,” as used herein, includes any device capable of supplying power suitable for welding, plasma cutting, induction heating, Carbon Arc Cutting-Air (e.g., CAC-A), and/or hot wire welding/preheating (including laser welding and laser cladding), including inverters, converters, choppers, resonant power supplies, quasi-resonant power supplies, etc., as well as control circuitry and other ancillary circuitry associated therewith.

As used herein, the term “welding-type power” refers to power suitable for welding, plasma cutting, induction heating, CAC-A and/or hot wire welding/preheating (including laser welding and laser cladding). As used herein, the term “welding-type power supply” and/or “power supply” refers to any device capable of, when power is applied thereto, supplying welding, plasma cutting, induction heating, CAC-A and/or hot wire welding/preheating (including laser welding and laser cladding) power, including but not limited to inverters, converters, resonant power supplies, quasi-resonant power supplies, and the like, as well as control circuitry and other ancillary circuitry associated therewith.

As used herein, the term “torch,” “welding torch,” “welding tool” or “welding-type tool” refers to a device configured to be manipulated to perform a welding-related task, and can include a hand-held welding torch, robotic welding torch, gun, gouging tool, cutting tool, or other device used to create the welding arc.

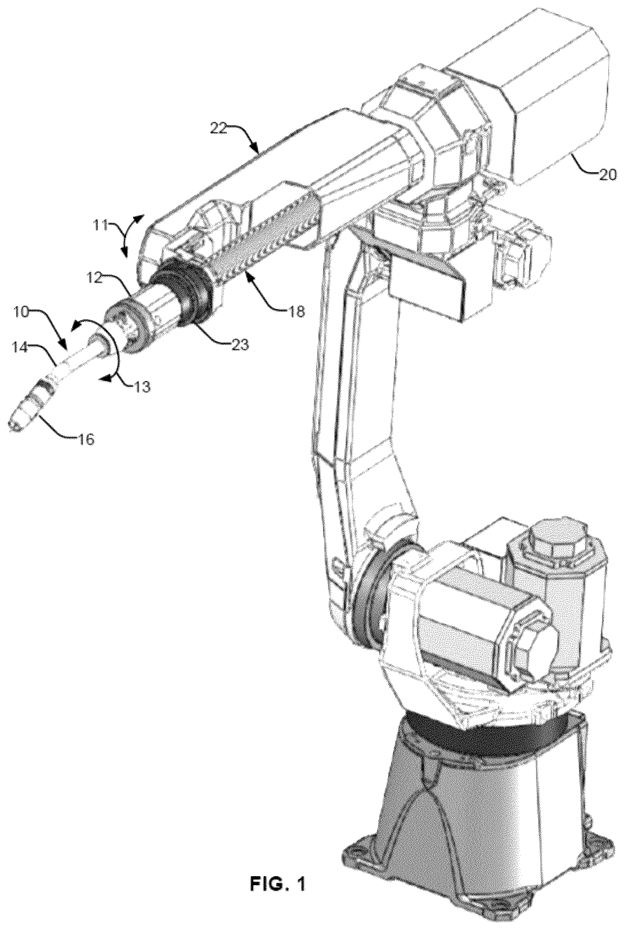

Turning now to the figures, FIG. 1 provides a perspective view of an example robotic welding system employing an example welding cable connection assembly 100. An electric welding torch 10 (e.g., a gas metal arc welding (GMAW) torch, a metal inert gas (MIG) torch, etc.) is comprised of a torch body having a main housing 12, a gooseneck 14, and a contact tip or nozzle assembly 16, a power cable, such as a unicable assembly 18, and a power pin (not shown) that mates with the wire feeder 20. The shielding gas, electrical current, and a consumable electrode (e.g., a welding wire) are channeled through the torch 10 to output a welding arc at the nozzle assembly 16.

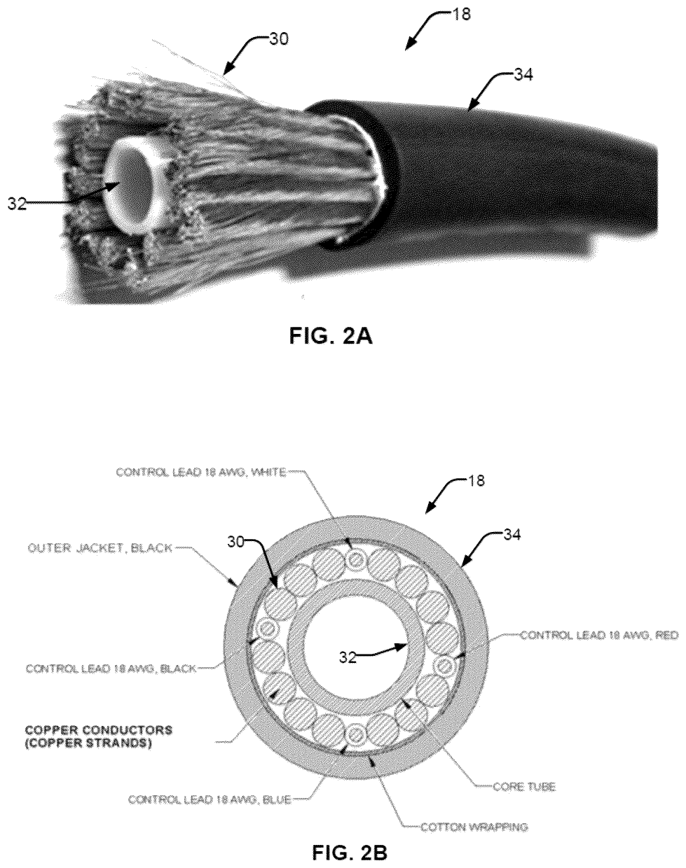

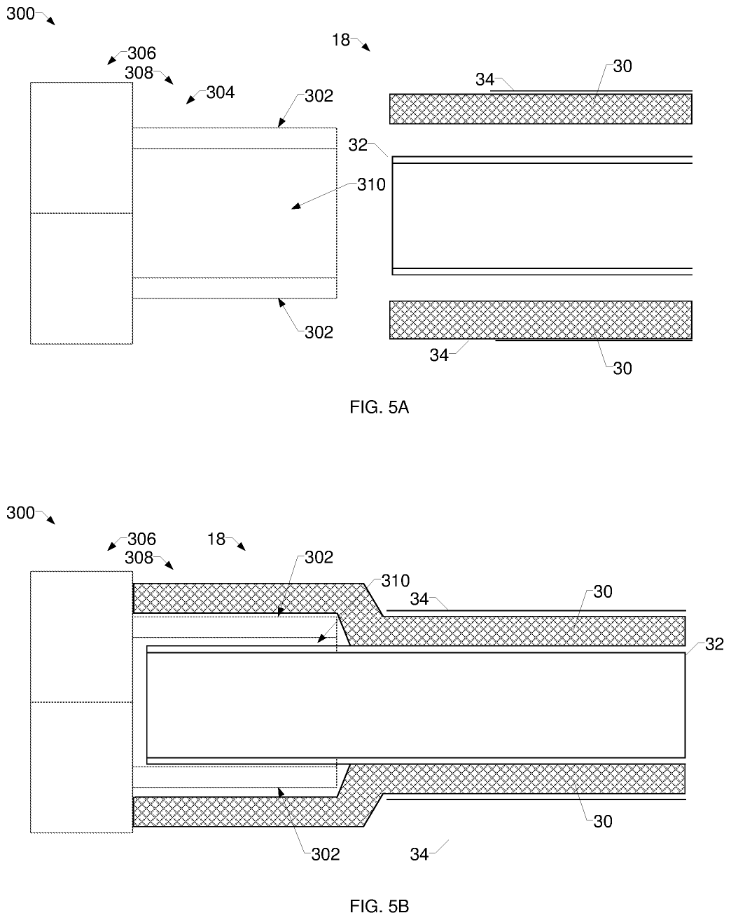

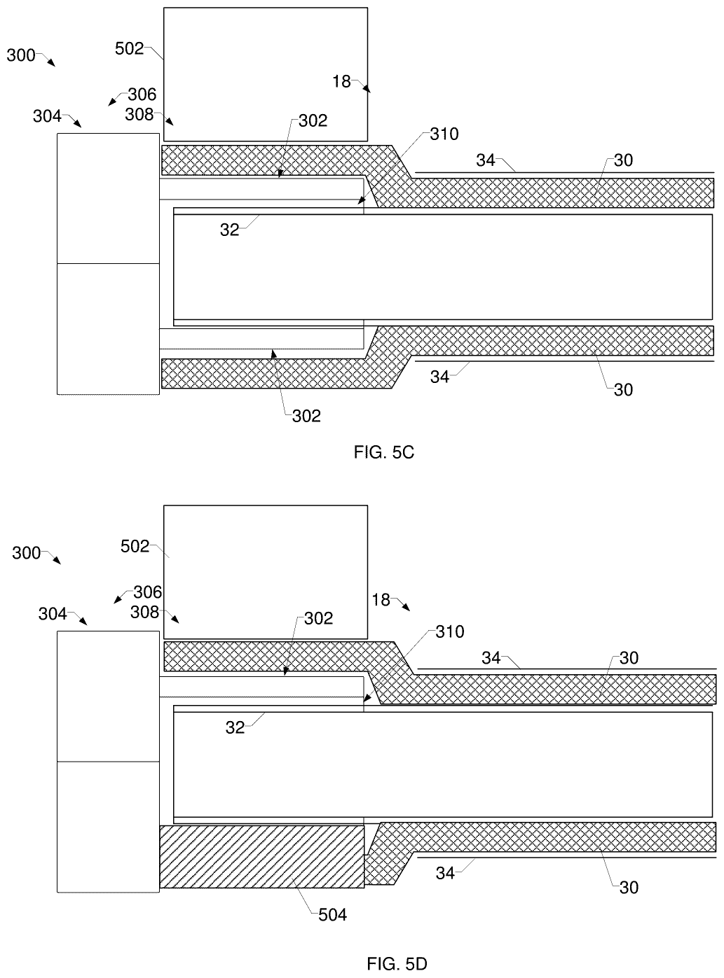

In some examples, an example welding cable connection assembly (e.g., welding cable connection assembly 500 of FIGS. 5A and 5B) is arranged within a robotic arm 22 (e.g., the main housing 12), providing a conducting assembly between the unicable assembly 18 and the torch 10. As shown in FIGS. 2A and 2B, the example unicable assembly 18 includes a conduit 43 (core tube), metallic/copper wire strands 30 (also referred to herein as conductors, strands, and/or wires), an outer jacket 34, and/or one or more shielded lead wires 36. FIG. 2B provides a cross-sectional view of the unicable 18. In the illustrated unicable, the conductors (e.g., metallic, copper, etc.) are made of multiple bundles of the conductive strands 30, as well as insulated wire leads (e.g., communication leads) are wrapped within the conductive strands 30.

Returning to FIG. 1, the unicable 18 may be connected to a wire feeder 20 opposite the main housing 12 of the welding torch 10. The gooseneck 14 is operatively connected to a forward end of the main housing 12 and allows for the communication of the consumable electrode, the shielding gas, and/or the welding current to the nozzle assembly 16 mounted on the gooseneck. The welding torch 10 is coaxially mounted to the robotic arm 22 such that the unicable 18 is arranged along the center axis of the robotic arm 22. However, the welding torch 10 may be mounted to a robotic arm in a disposition other than a coaxially mounted disposition. In some examples, the robotic arm 22 is configured to bend and/or rotate the welding torch 10 in direction 11, as well as bend and/or rotate in direction 13, generally about the center axis of the robotic arm 22. For instance, a motor or other actuator 23 is employed to control movement of the welding torch 10 via the main housing 12 in one or more directions 13.

The wire feeder 20 feeds the welding wire through the unicable 18, main housing 12, gooseneck 14, and ultimately through an opening in the contact tip/nozzle assembly 16 at the forward end of the welding torch 10. The welding wire, when energized for welding, carries a high electrical potential. When the welding wire arcs with metal workpieces, an electrical circuit is completed and current flows through the welding wire, across the arc to metal workpieces and to a ground or other type of current return. The arc causes the welding wire and the metal of the workpieces to melt, thereby joining the workpieces as the melt solidifies.

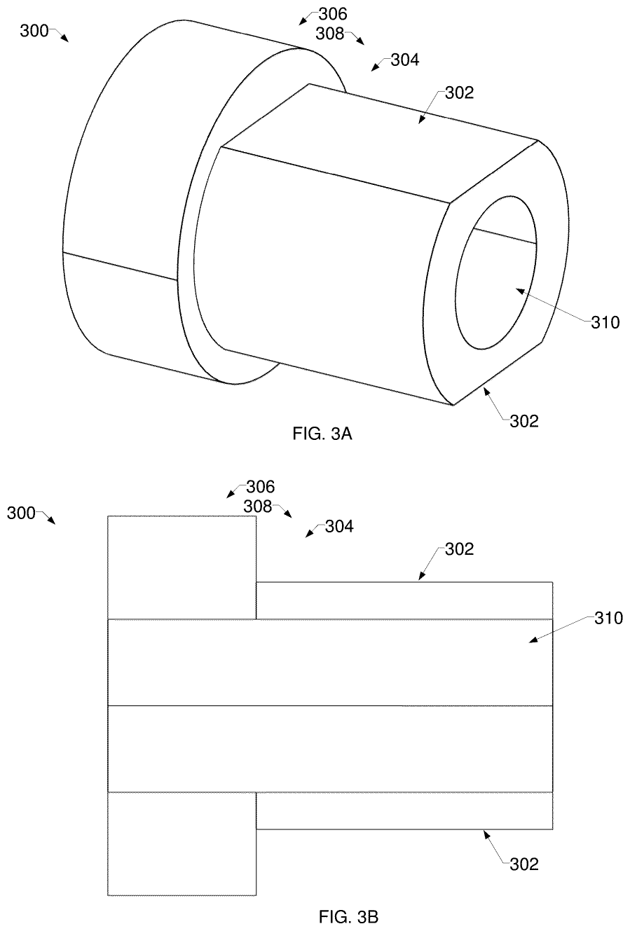

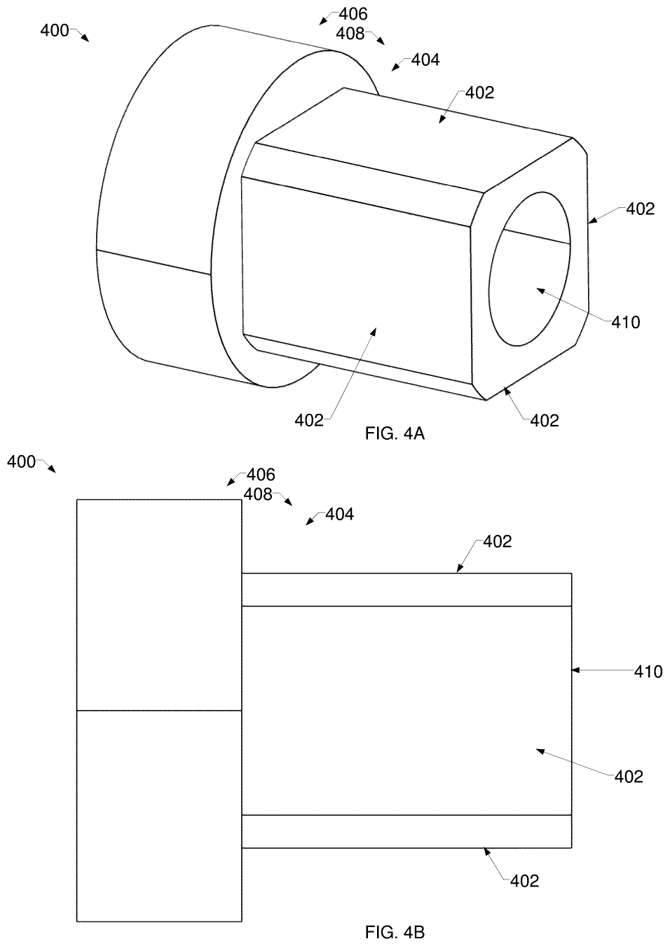

FIG. 3A is a perspective view of an example fitting 300 having two flat surfaces 302 that may be ultrasonically welded to the unicable assembly 18 of FIGS. 2A and 2B. FIG. 3B is a side elevation cross-section view of the example fitting 300. FIG. 4A is a perspective view of another example fitting 400 having four flat surfaces 402 that may be ultrasonically welded to the unicable assembly 18 of FIGS. 2A and 2B. FIG. 4A is a perspective view of the example fitting 400. The example fitting 400 is similar to the fitting 300 with the exception of the number of flat surfaces.

The fittings 300, 400 have a body 304, 404 with a first portion 306, 406 and a second portion 308, 408. The body 304, 404 is constructed from brass, copper, bronze, aluminum, a copper alloy, and/or any other appropriate conductive material.

The body 304, 404 has a bore 310, 410 extending through the body 304, 404. The bore 310, 410 has a diameter which enables the conduit 43 to be inserted through the bore 310, 410 when the unicable assembly 18 is affixed to the fitting 300, 400.

The first portion 306, 406 is a head portion, which may be coupled to another front-end and/or back-end welding connector, a welding-type torch body, a gooseneck of a welding torch, a welding nozzle assembly, a welding-type power supply, a wire feeder, and/or any other connection in a welding-type system.

The second portion 308, 408 includes the two flat surfaces 302, 402 for connection to the conductive strands 30 of the unicable assembly 18. As described in more detail below, respective portions of the conductive strands 30 may be pressed into contact with the flat surfaces 302, 402 and ultrasonically welded to the flat surfaces 302, 402. In some examples, the conductive strands 30 are welded to one of the flat surfaces 302, 402 at a time to avoid interference between ultrasonic signals introduced from different directions to the assembly. Additionally or alternatively, a mandrel may be inserted into the bore 310, 410 to mitigate the ultrasonic signal on the side(s) of the body 304, 404 that are not adjacent the sonotrode.

FIG. 5A illustrates a cross-section of the example unicable assembly 18 of FIGS. 2A and 2B prior to connection to the fitting 300 of FIGS. 3A and 3B for ultrasonic welding during a manufacturing process. FIG. 5B illustrates the unicable assembly 18 engaged with the fitting 300. FIG. 5C illustrates a cross-section of the unicable assembly 18 and the fitting 300 during a first portion of the ultrasonic welding process, and FIG. 5D illustrates a cross-section of the unicable assembly 18 and the fitting 300 during a second portion of the ultrasonic welding process.

The unicable assembly 18 and the fitting 300 are illustrated in FIG. 5A prior to connection of the unicable assembly 18 to the fitting 300. The fitting 300 may be secured in a fixture, such as a clamp, mandrel, and/or other type of fixturing. A section of the jacket 34 is removed to expose and enable manipulation of the conductive strands 30.

FIG. 5B illustrates the unicable assembly 18 connected to the fitting 300. As shown in FIG. 5B, the conduit 43 is inserted into the bore 310 in the fitting 300, while the exposed conductive strands are slid over the exterior of the section portion 308 of the body 304. In the illustrated example, the conductive strands 30 may be bent or manipulated in an outward direction to fit over the second portion 308 of the body 304. The conductive strands 30 may be shifted and/or bundled to increase the concentration of the conductive strands 30 that are adjacent to the flat surfaces 302.

FIG. 5C illustrates a first example stage of ultrasonically welding the unicable assembly 18 to the fitting 300. As illustrated in FIG. 5C, a first portion of the conductive strands 30 are pressed against a first one of the flat surfaces 302 by a sonotrode 502, which further outputs ultrasonic energy into the conductive strands 30 and the body 304 to ultrasonically weld the conductive strands 30 to the body 304.

FIG. 5D illustrates a second example stage of ultrasonically welding the unicable assembly 18 to the fitting 300 following the first example stage of FIG. 5C. Between the first stage of FIG. 5C and the second stage of FIG. 5D, the unicable assembly 18 and the fitting 300 are rotated over the longitudinal axis of the unicable assembly 18 and the fitting 300 to cause a second one of the flat surfaces 302 and a second portion of the conductive strands 30 to face the sonotrode 502. For example, the two-surface fitting 300 may involve a 180-degree rotation, while the four-surface fitting 400 may involve 90-degree rotations (or a mix of 180-degree and 90-degree rotations). The second portion of the conductive strands 30 are then pressed against the second one of the flat surfaces 302 by the sonotrode 502. The sonotrode 502 then outputs the ultrasonic energy into the conductive strands 30 and the body 304 to ultrasonically weld the conductive strands 30 to the body 304.

The rotation and ultrasonic welding may be repeated for additional flat surfaces and portions of the conductive strands 30. Additionally or alternatively, different sonotrodes may be placed into contact with different ones of the surfaces 302 to reduce or avoid rotations of the fitting 300 and the unicable assembly 18.

After the ultrasonic welding, the welded conductive strands 30 may be covered with an insulator, and/or the welded assembly may be coupled to a larger assembly (e.g., the fitting 300, 400 may be coupled to a connector). Additionally or alternatively, the other end of the unicable assembly 18 may be connected to the same or different connector via ultrasonic welding and/or a conventional attachment method.

The first welded portion of the conductive strands 30 and flat surface 302 become a weldment 504, which is coupled to the unwelded conductive strands 30 in the unicable assembly 18.

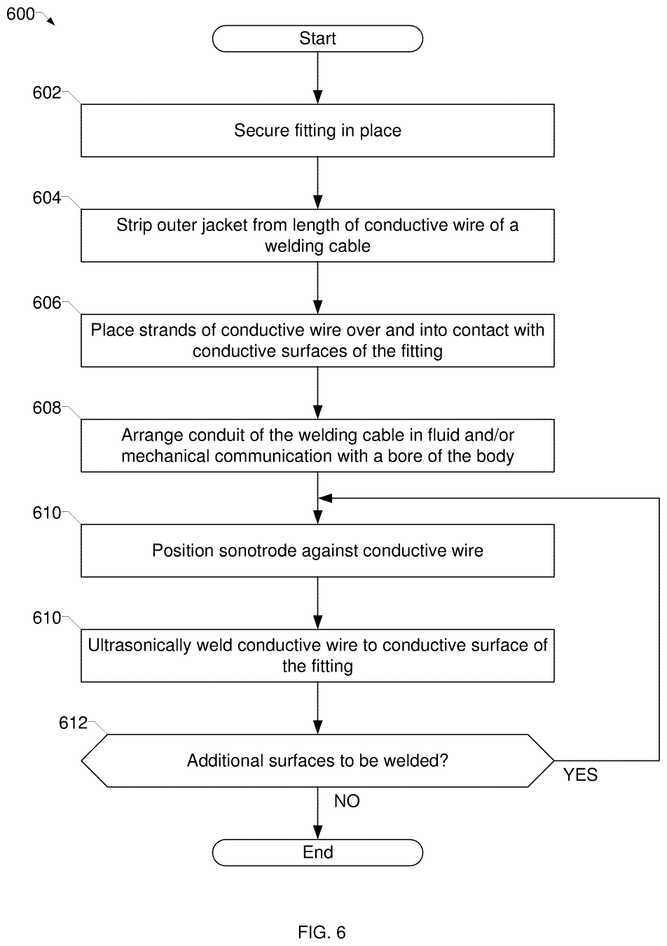

FIG. 6 is a flowchart representative of an example method 600 to construct a welding cable using ultrasonic welding. The example method 600 is discussed below with reference to the assembly of FIGS. 5A-5D above.

At block 602, the fitting 300 is secured in place. For example, the fitting 300 may be secured to a clamp and/or mandrel. At block 604, the outer jacket 34 is stripped from a length of the conductive strands 30 of the unicable assembly 18. The length of outer jacket 34 that is stripped may correspond to the length of the conductor strands 30 to be welded to the fitting 300. At block 606, the conductive strands 30 are placed over and into contact with the flat surfaces 302 of the fitting 300. For example, portions of the strands 30 may be separated for increased density adjacent the flat surfaces 302. In some other examples, the strands 30 may be inserted into and placed into contact with internal surfaces, such as a bore having a larger diameter than the example bore 310.

At block 608, the conduit 43 of the unicable assembly 18 is arranged in fluid and/or mechanical communication with the bore 310 of the body 304. For example, the conduit 43 may be inserted into the bore 310 to allow conveyance of welding gas and/or welding wire through the fitting 300 via the conduit 43 and the bore 310.

At block 610, a sonotrode 502 is placed against the conductive strands 30. For example, the sonotrode 502 may clamp a portion of the conductive strands 30 against one of the flat surfaces 302 to ensure adequate contact for welding. At block 612, the sonotrode 502 ultrasonically welds the portion of the conductive strands 30 to the flat surface 302 of the fitting 300.

At block 612, it is determine whether there are additional surfaces to be welded. If there are additional surfaces of the fitting 300 to be welded to the conductive strands 30, control returns to block 610 to place a different flat surface 302 of the fitting 300 and a different portion of the conductive strands 30 into contact with the fitting 300.

When no additional surfaces are to be welded (block 612), the example method 600 ends. However, in some examples, additional steps to insulate and/or protect the exposed conductor, and/or additional manufacturing steps, may be performed.

In some examples, the conduit 43 can be constructed of one or more materials, including metals, alloys, polymers, and/or a combination thereof. Some materials used in construction of the core tube(s) include steel mono coil, Hytrel®, and/or Teflon®, as a list of non-limiting examples.

In some examples, one or more conductive materials can be used to construct the connector(s) 102, such as such as copper, bronze, aluminum, silver, metal alloys, and/or other conductive materials.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A welding cable, comprising:
an outer jacket;
a plurality of strands of conductive wire arranged within the outer jacket;
a conduit within the outer jacket; and
a fitting configured to couple the welding cable to an external device, the fitting comprising a body having a bore in communication with the gas conduit and having a conductive surface ultrasonically welded to the plurality of strands of the conductive wire.

2. The welding cable as defined in claim 1, wherein the conduit is in a center of the outer jacket, and the plurality of strands are arranged around an outside of the conduit.

3. The welding cable as defined in claim 1, wherein the conduit is configured to convey at least one of gas or welding wire.

4. The welding cable as defined in claim 1, wherein the conduit is configured to convey gas, and further comprising a second conduit configured to be placed into communication with a second bore of the fitting and configured to convey welding wire.

5. The welding cable as defined in claim 1, wherein the body is constructed from brass, copper, bronze, aluminum, or a copper alloy.

6. The welding cable as defined in claim 1, wherein the plurality of strands of the conductive wire are ultrasonically welded to the conductive surface on an exterior surface of the body.

7. The welding cable as defined in claim 1, wherein the body comprises two or more flat surfaces that are ultrasonically welded to respective portions of the plurality of strands of the conductive wire.

8. The welding cable as defined in claim 1, wherein the fitting is configured to be coupled to at least one of a welding-type torch, a welding-type power supply, a wire feeder, or a cable connector.

9. A method of manufacturing a weld cable, the method comprising:
securing a fitting, the fitting comprising a body having a bore and a plurality of conductive surfaces arranged around a circumference of at least a portion of the body;
placing a plurality of strands of conductive wire of a weld cable over and into contact with the conductive surfaces;
arranging a conduit of the weld cable in communication with the bore of the body; and
ultrasonically welding the plurality of strands of the conductive wire to the plurality of conductive surfaces to secure the weld cable to the fitting.

10. The method as defined in claim 9, wherein the ultrasonically welding the plurality of strands to the plurality of conductive surfaces comprises ultrasonically welding a portion of the plurality of strands to one of the conductive surfaces at a time.

11. The method as defined in claim 10, wherein the ultrasonically welding the plurality of strands to the plurality of conductive surfaces comprises turning the weld cable and the fitting with respect to a sonotrode between welds of respective subsets of the plurality of strands to corresponding ones of the conductive surfaces.

12. The method as defined in claim 9, wherein the plurality of conductive surfaces comprise flat surfaces arranged around the circumference of a portion of the body.

13. The method as defined in claim 9, wherein the fitting comprises one, two, or four conductive surfaces to which the plurality of strands of the conductive wire are ultrasonically welded.

14. The method as defined in claim 9, wherein the fitting comprises brass or copper.

15. The method as defined in claim 9, wherein arranging the conduit of the weld cable in fluid communication with the bore of the body comprises at least partially inserting the conduit of the weld cable into the bore while the plurality of strands of the conductive wire are pushed over an exterior surface of the body.
